(19) United States
(12) Patent Application Publication
(10) Pub. No.: US 2016/0210417 A1
(43) Pub. Date: Jul. 21, 2016

(54) CLINICAL PATH MANAGEMENT DEVICE

(71) Applicant: FUJIFILM Corporation, Tokyo (JP)

(72) Inventors: Yuya KUDO, Tokyo (JP); Satoshi UEDA, Tokyo (JP); Hironori MATSUMASA, Tokyo (JP); Yasunori OHTA, Ashigarakami-gun (JP)

(73) Assignee: FUJIFILM Corporation, Tokyo (JP)

(21) Appl. No.: 15/084,016

(22) Filed: Mar. 29, 2016

Related U.S. Application Data
(63) Continuation of application No. PCT/JP2014/075186, filed on Sep. 24, 2014.

(30) Foreign Application Priority Data
Sep. 30, 2013 (JP) 2013-204302

(51) Int. Cl. G06F 19/00; H04L 29/06

(52) U.S. Cl. CPC G06F 19/325; H04L 63/08

(57) ABSTRACT

A clinical path approval unit extracts clinical paths for which a user has approval authority by referring to authority information of the clinical paths stored in a clinical path DB, and causes the user to select a clinical path to be approved from among the extracted clinical paths. If the clinical path to be approved is selected, information (digital signature) indicating that the clinical path is approved and a certificate for certificating that this approval has been made from a terminal of a user having approval authority are generated. The clinical path approval unit stores the digital signature or the certificate in association with the approved clinical path to update the clinical path DB.

### CROSS-REFERENCE TO RELATED APPLICATIONS

This application is a Continuation of PCT International Application No. PCT/JP2014/075186 filed on Sep. 24, 2014, which claims priority under 35 U.S.0 §119 (a) to Japanese Patent Application No. 2013-204302 filed Sep. 30, 2013. The above application is hereby expressly incorporated by reference, in its entirety, into the present application.

### BACKGROUND OF THE INVENTION

1. Field of the Invention

The present invention relates to a clinical path management device that manages a clinical path.

2. Description Related to the Prior Art

In recent years, a clinical path has been introduced in medical institutions. The clinical path is intended to show a treatment plan (treatment or test) of a patient. By creating the clinical path and visualizing the treatment plan, information can be shared among medical staff such as doctors or nurses in a medical institution, and high-quality stable treatment can be performed. Further, a patient can understand the treatment plan and receive the treatment with confidence.

In general, the clinical path is managed in the form of paper that has been printed out, but there is a device that manages a clinical path in the form of electronic data, as in a clinical path management device described in WO2005/122033A. In the clinical path management device of WO 2005/122033A, the clinical path can be viewed by accessing a database in which the clinical path has been stored, from various terminals such as a terminal of medical staff or a terminal of a patient. Further, in WO2005/122033A, a function of setting viewing authority or editing authority for the clinical path and allowing only a user who has the viewing authority or the editing authority to view or edit the clinical path is incorporated.

However, in the clinical path management device described in WO2005/122033A, there are many inconveniences when the treatment is actually performed based on the clinical path, and there is a problem in that smooth treatment is obstructed.

That is, when the treatment is actually performed, a patient's approval is necessary. The medical institution describes a content of the treatment to the patient, receives the patient's approval, and then, performs the treatment. The patient submits a written consent to the medical institution to approve the treatment.

The written consent indicating that the treatment has been approved is often managed separately from the clinical path, and whether the approval of the patient has been obtained is often not recognized by only viewing the clinical path. Therefore, when the treatment described in the clinical path is performed, it is necessary to separately confirm the written consent, which obstructs progress of smooth treatment.

### SUMMARY OF THE INVENTION

An object of the present invention is to provide a clinical path management device capable of smooth treatment.

To achieve the above object, a clinical path management device of the present invention includes a clinical path database, a user information database, a user authentication unit, and a clinical path approval unit. In the clinical path database, a clinical path showing a treatment plan of a patient is stored. The user information database stores user information of a user.

The user authentication unit authenticates the user based on the user information. The clinical path approval unit associates information indicating that the treatment plan has been approved with the clinical path upon an input of an instruction to approve the treatment plan from a user having approval authority for approving the treatment plan.

The clinical path management device may further include an approval authority changing unit that receives an instruction to grant or delete the approval authority from a user having approval authority changing authority for granting or deleting the approval authority, and grants or deletes the approval authority upon an input of the instruction.

The clinical path management device may further include a clinical path distribution unit that receives an instruction to view the clinical path from a user having viewing authority for viewing the clinical path, and distributes the clinical path upon an input of the instruction is input.

The clinical path management device may further include a clinical path creation unit that receives an instruction to create the clinical path from a user having creation authority for creating the clinical path, and creates the clinical path upon an input of the instruction.

Authority possessed by the user may be stored in association with the clinical path.

Preset authority may be granted to a pre-set user at the time of creation of the clinical path.

At the time of creation of the clinical path, the approval authority may be granted to the patient who is a treatment target in the clinical path, and the approval authority changing authority may be granted to the patient and an attending doctor of the patient.

The approval authority changing authority granted to the attending doctor may be authority for granting the approval authority to only a relative of the patient.

At the time of creation of the clinical path, the viewing authority may be granted to the patient who is a treatment target in the clinical path, and the attending doctor of the patient.

The viewing authority granted to the attending doctor may be authority for viewing all information constituting the clinical path, and the viewing authority granted to the patient may be authority for viewing only a part of the information constituting the clinical path.

According to the present invention, the clinical path is stored in the database, and if an instruction to approve the clinical path is input from a user having approval authority for the clinical path, this fact is stored in association with the clinical path, that is, the clinical path and information on presence or absence of the approval are centrally managed. Accordingly, it becomes possible to confirm the presence or absence of the approval simply by viewing the clinical path, and to perform smooth treatment, as compared with a case in which a document such as a written consent is managed separately from the clinical path.

### BRIEF DESCRIPTION OF DRAWINGS

For more complete understanding of the present invention, and the advantage thereof, reference is now made to the subsequent descriptions taken in conjunction with the accompanying drawings, in which:

FIG. 1 is a schematic diagram illustrating a configuration of a medical support system;

FIG. 2 is an illustrative diagram illustrating a data structure of a clinical path;

FIG. 3 is an illustrative diagram illustrating a state in which the clinical path is displayed;

FIG. 4 is an illustrative diagram illustrating user information;

FIG. 5 is a block diagram illustrating a configuration of an application server;

FIG. 6 is a functional configuration diagram of the application server;

FIG. 7 is an illustrative diagram illustrating a function of the clinical path creation/changing unit;

FIG. 8 is an illustrative diagram illustrating a function of a clinical path distribution unit;

FIG. 9 is an illustrative diagram illustrating a function of a clinical path approval unit;

FIG. 10 is an illustrative diagram illustrating a function of an authority changing unit; and

FIG. 11 is an illustrative diagram illustrating an authority changing screen.

### DESCRIPTION OF THE PREFERRED EMBODIMENTS

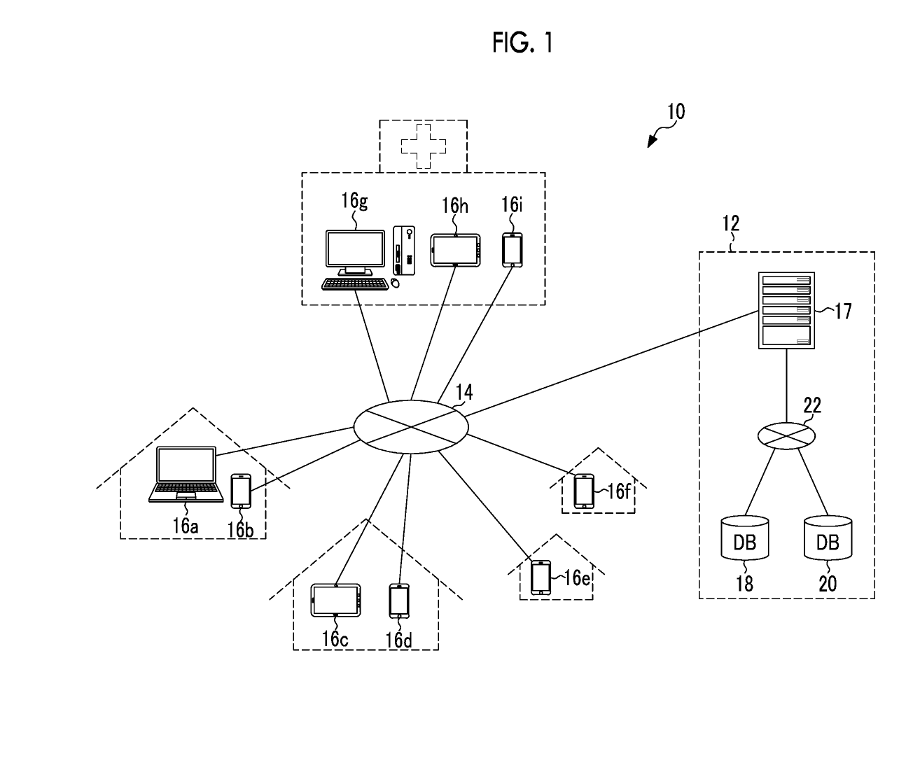

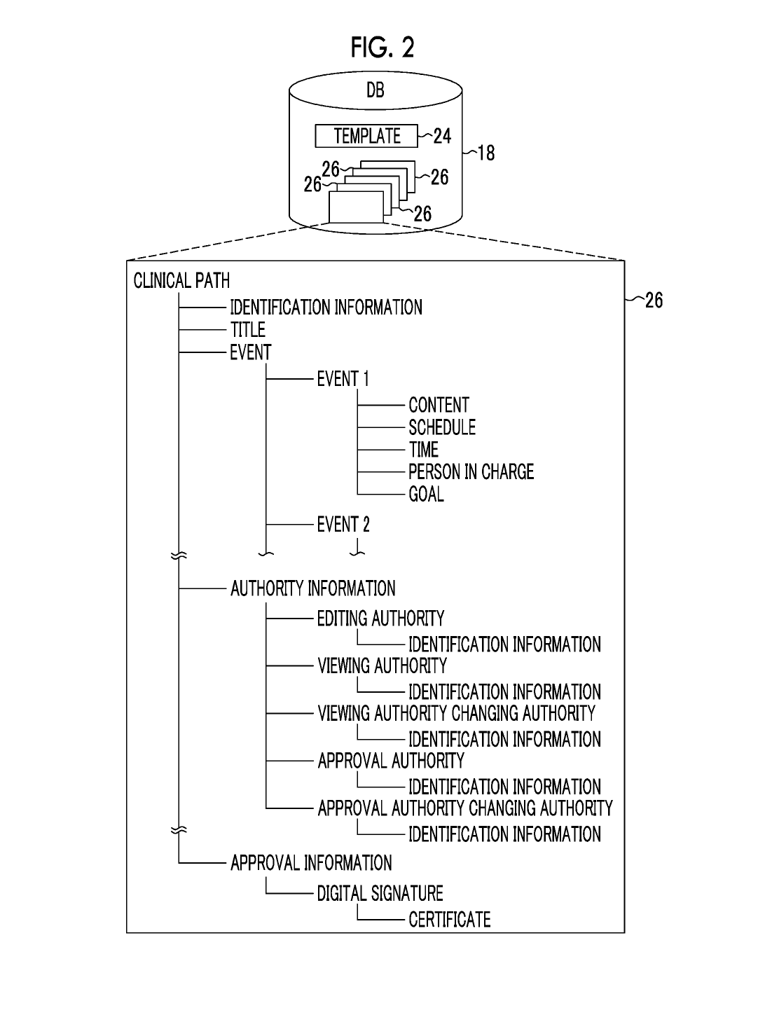

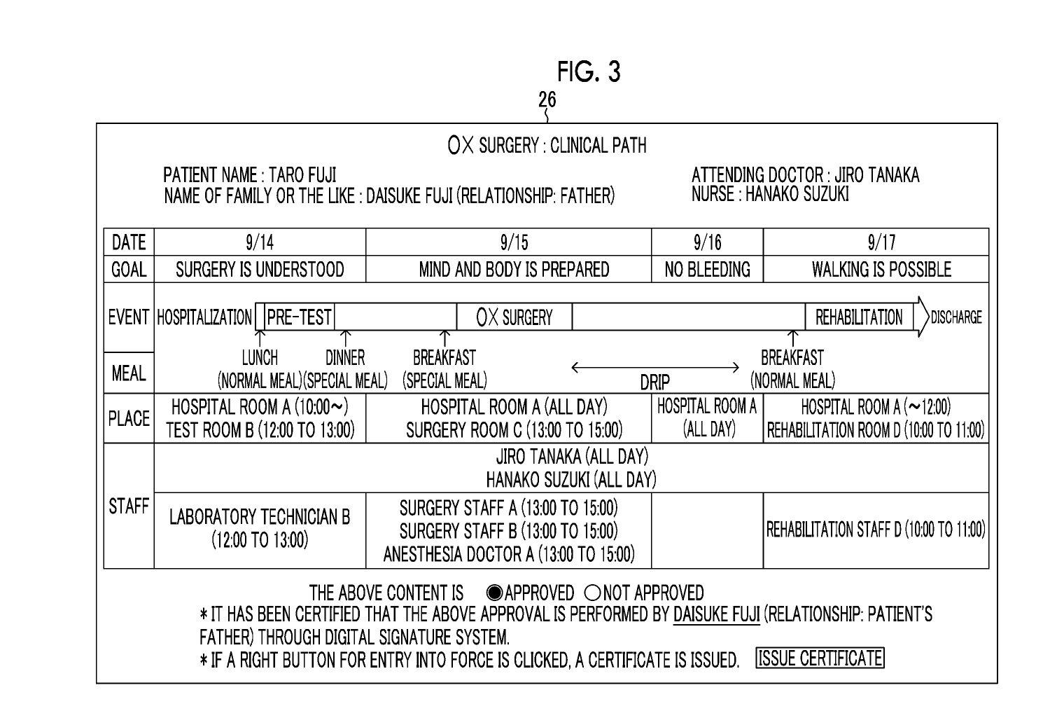

In FIG. 1, a medical support system 10 supports medical care using a clinical path 26 (see FIGS. 2 and 3), and includes a clinical path management device 12 that performs management (for example, creation or editing, storage, or distribution) of a clinical path 26. Terminals 16a to 16i of users of the medical support system 10 are communicably connected to the clinical path management device 12 over a network 14 such as the Internet. The clinical path management device 12 distributes an operation screen such as a Graphical User Interface (GUI) to the terminals 16a to 16i over the network 14, and performs management of the clinical path 26 according to an operation instruction input from the terminals 16a to 16i through the operation screen.

The terminals 16a to 16i are well-known electronic devices such as a desktop type personal computer, a notebook type personal computer, a tablet terminal, a mobile phone, or a smart phone, which include a function of connection to the network 14, and input means such as a keyboard or a mouse or display means such as a liquid crystal display (or a touch panel type display including both of input means and display means). The terminals 16a to 16i are used by users of the medical support system 10. The users of the medical support system 10 include patients, users on the patient side such as his or her relative or friend, or users on the medical institution side such as an attending doctor responsible for treatment of the patient or medical staffs serving as assistants of the attending doctor.

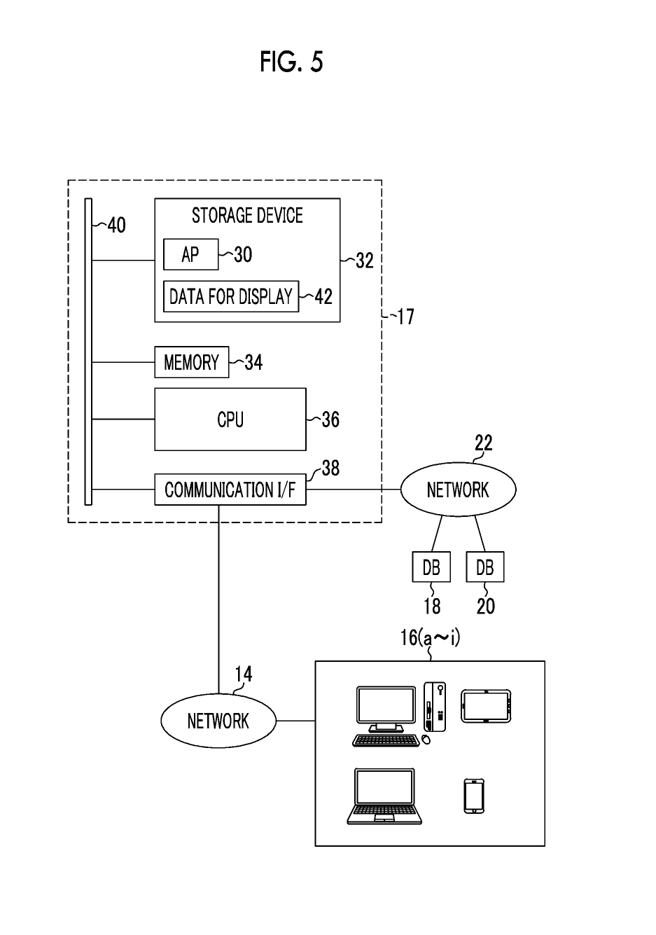

The clinical path management device 12 is installed in, for example, a management company that manages the medical support system 10. The clinical path management device 12 includes an application server 17 that executes various functions such as distribution of an operation screen or management of the and clinical path 26 according to an application program (AP) 30 (see FIG. 5) to be described below, a clinical path database (DB) 18, and a user information DB 20, which are connected via a network 22 such as a LAN.

As illustrated in FIGS. 2 and 3, a template 24 which is a base when the clinical path 26 is newly created, and the created clinical paths 26 created based on the template 24 are stored in a clinical path DB 18. FIG. 2 illustrates a structure of data constituting the clinical path 26, and FIG. 3 illustrates a state in which the clinical path 26 is displayed to be viewed on the display.

The clinical path 26 shows a treatment plan for a patient and is created for each patient who is a treatment target. In the clinical path 26, for example, various information such as identification information (for example, a user ID (Identification Data)) for identifying the patient who is a treatment target, a goal in each step in a case in which a treatment plan is divided into a plurality of steps, and content (date, time, place, person in charge, and goal) of the treatment (event) in each step are associated with each other.

Further, authority information is associated with the clinical path 26. Types of right includes editing authority with which clinical path 26 can be edited (for example, addition or deletion of an event, or changing of date or time, place, or person in charge) or viewing authority with which the clinical path 26 can be viewed, which is authority to use the content of the clinical path 26, and approval authority with which the content of the clinical path 26 can be approved. Further, authorities to manage a range of users who use the clinical path 26 include viewing authority changing authority to perform authority changing such as granting or deletion of the viewing authority for each user, and approval setting authority to perform authority changing such as granting or deletion of the approver authority for each user. Authority information is information in which each of the authorities, and identification information (for example, a user ID) for identifying the user having each authority is associated with each other.

When the clinical path 26 is newly created, authority in an initial state granted to each user is preset, and when the clinical path 26 is newly created, pre-set authority is automatically granted to a preset user. Specifically, editing authority is granted to the attending doctor, viewing authority is granted to the patient, the attending doctor, and medical staffs involved in the event, viewing authority changing authority is granted to the patient and the attending doctor, approval authority is granted to the patient, and approval authority changing authority is granted to the patient and the attending doctor. The authority in the initial state granted to each user is not limited to the above-described example and may be appropriately changed.

Further, approval information (for example, digital signature or a certificate) indicating whether or not approval is obtained from a person having approval authority for the treatment plan shown in the clinical path 26 is also associated with the clinical path 26. The approval authority is granted to the patient in an initial state. The approval information is information indicating whether or not the patient has agreed to the treatment plan. Ina case in which approval is obtained, the fact indicating that the approval has been obtained is recorded, and in a case in which the approval is not obtained, the fact indicating that the approval has not been obtained is recorded.

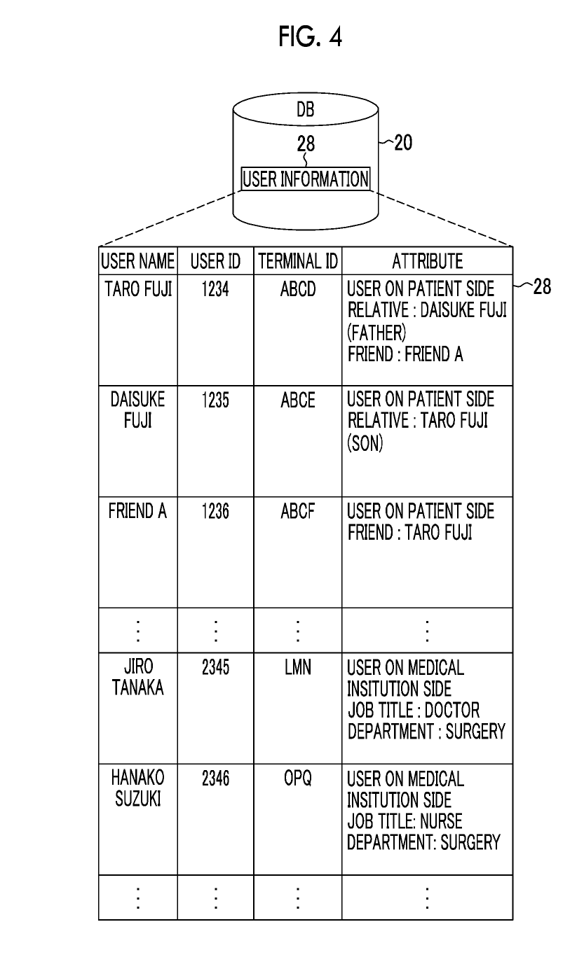

As illustrated in FIG. 4, user information 28 on the user is stored in the user information DB 20. In the user information 28, identification information for identifying the user, such as a the user name and a user ID, a terminal ID for identifying a terminal owned by the user, and attribute information of the user (for example, a standpoint of the user (whether the user has a standpoint of a patient or the patient side such as his or her relative or friend), a relationship with another user in a case in which the user is in the standpoint of the patient side (information indicating relatives or friends of the user), or a job title or a department in a case in which the user is in the standpoint of a medical institution side) are associated.

The user information 28 is divided according to each user, the user information of one person is generated, for example, in a user registration process performed at the time of first use of the medical support system 10 and stored (newly registered) in the user information DB 20. In the user registration process, a user that has made a use application of the clinical path management device 12 in advance is required to input a user name and attribute information. If the user inputs the user name and the attribute information from the own terminal, the user ID is assigned, a terminal ID of a terminal which is an information input source is acquired, and the terminal ID is associated with the user ID along with the user name and the attribute information. Accordingly, user information is generated.

The user registration is not limited to the example in which the user inputs his or her user information to register the user, and may be performed using an appropriate method. For example, the user (patient) may register his or her relative or friend as a user. In this case, the patient may input user information such as a name or a terminal ID of the relative to be registered as a user from his or her terminal. It is understood that the attending doctor of the patient may register the relative of his or her patient by inputting the user information such as the name or the terminal ID of the relative of the patient from his or her terminal.

As illustrated in FIG. 5, the application server 17 is configured by installing a control program such as an operating system or an AP 30 for causing a computer to function as the application server 17, based on a computer such as a personal computer or a workstation.

The application server 17 includes a storage device 32, a memory 34, a Central Processing Unit (CPU) 36, and a communication I/F 38, which are connected via a data bus 40. The storage device 32 is, for example, a hard disk drive, and is an internal storage embedded in a main body of the application server 17. A control program, an application program (AP) 30 such as application server software, an image or a message displayed at the time of execution of the AP 30, display data 42 for a display for displaying various operation screens, or the like are stored in the storage device 32.

The memory 34 is a work memory used for the CPU 36 to execute a process. The CPU 36 loads the control program stored in the storage device 32 into the memory 34 and executes the process according to the program to generally control each unit of the computer. The communication I/F (Inter/face) 38 includes an interface for communication with the network 14 or 22, and the application server 17 communicate with the clinical path DB 18, the user information DB 20, and the terminals 16a to 16i via the communication I/F 38 over the network 14 or 22.

The AP 30 is a program for causing the computer to execute various functions. The CPU 36 loads the AP 30 stored in the storage device 32 into the memory 34 and executes a process according to the program, to generally control each unit of the computer.

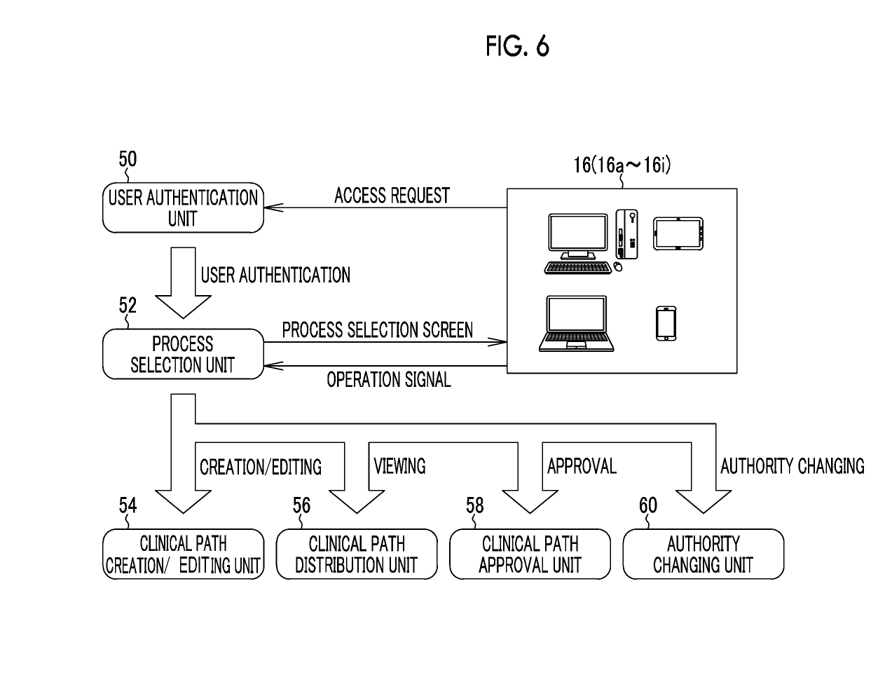

As illustrated in FIG. 6, if the AP 30 starts up, the CPU 36 functions as a user authentication unit 50, a process selection unit 52, a clinical path creation/editing unit 54, a clinical path distribution unit 56, a clinical path approval unit 58, and an authority changing unit 60 in cooperation with the memory 34.

The user authentication unit 50 receives a request for access to the medical support system 10, which is input from the terminals 16a to 16i, and performs user authentication. The access request is transmitted to the user authentication unit 50, for example, by a management company of the medical support system 10 inputting a user ID in a Web site opened on the network 14. If the user authentication unit 50 receives the access request, the user authentication unit 50 authenticates the user by matching the user ID input together with the access request with the user information 28. By the user being authenticated, the user can be identified, and relatives or friends of the user can be identified based on the information on the relatives or the friends stored in the attributes of the user information 28. When the user authentication is performed, a password as well as the user ID may be input and the user authentication may be performed using the user ID and password.

If the user authentication is completed, the process selection unit 52 operates. The process selection unit 52 is provided in order to select content of the process to be executed by the AP 30, and selects content of the process to be executed by the AP 30 from among four processes including “clinical path creation/editing”, “clinical path viewing”, “clinical path approval”, and “authority changing” executable by the AP 30.

Specifically, the process selection unit 52 distributes a process selection screen which is an operation screen for selecting one of the four processes described above to the terminal 16 of the authenticated user. In the process selection screen, for example, four tags corresponding to the four processes described above are provided, and the user can operate his or her terminal 16 according to the process selection screen and click one of the four tags to select one process to be executed among the four processes. If the process is selected, an operation signal indicating content of the selection is input from the terminal 16 of the user to the process selection unit 52. The process selection unit 52 operates any one of the clinical path creation/editing unit 54, the clinical path distribution unit 56, the clinical path approval unit 58, and the authority changing unit 60 based on the input operation signal.

“Clinical Path Creation/Editing”

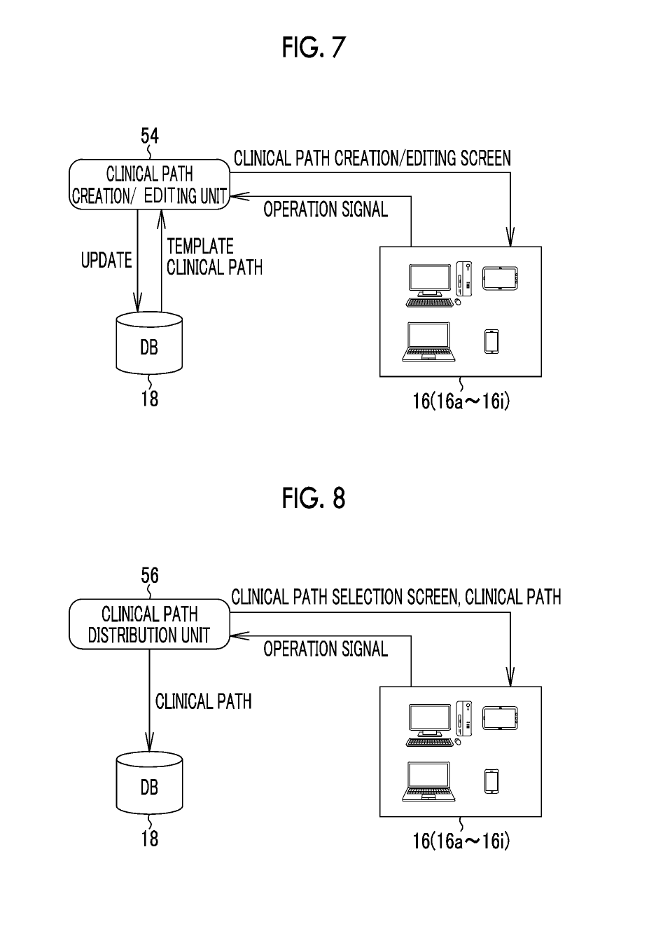

In FIG. 6, if the “clinical path creation/editing” is selected from among the four processes, the process selection unit 52 operates the clinical path creation/editing unit 54. As illustrated in FIG. 7, the clinical path creation/editing unit 54 distributes a clinical path creation/editing screen which is an operation screen for creating and editing the clinical path 26 according to the operation, to the terminal 16 of the authenticated user. An operation signal corresponding to the input operation that the user has performed through the clinical path creation/editing screen is input from the terminal 16 of the user to the clinical path creation/editing unit 54. The clinical path creation/editing unit 54 performs the creation and editing of the clinical path 26 based on the input operation signal.

In new creation of the clinical path 26, the clinical path creation/editing unit 54 causes the user to select one of the templates 24 of the clinical path 26 stored in the clinical path DB 18 and input date, a person in charge, a name of the patient, or the like. Further, in the editing of the clinical path 26, the clinical path creation/editing unit 54 extracts the clinical paths 26 for which the user has the editing authority by referring to the authority information of the created clinical path 26 stored in the clinical path DB 18, and causes the user to select one of the extracted clinical paths 26 to change the date or the person in charge or add a new event or the like.

The clinical path creation/editing unit 54 creates or edits the clinical path 26 based on the operation signal input according to the above-described work, newly records or overwrites the created or edited clinical path 26 in the clinical path DB 18 to update the clinical path DB 18. Creation authority to newly create the clinical path may be provided, information indicating whether or not a user has the authority to create the clinical path may be stored as user information, and only the user having the creation authority may be allowed to newly create the clinical path. In this case, for example, it may be considered that the creation authority is granted to only a user on the medical institution side.

“Clinical Path Viewing”

In FIG. 6, if the “clinical path viewing” among the four processes is selected, the process selection unit 52 operates the clinical path distribution unit 56. As illustrated in FIG. 8, the clinical path distribution unit 56 extracts the clinical paths 26 for which the user has viewing authority by referring to the authority information of the clinical path 26 stored in the clinical path DB 18 according to the operation, and distributes a clinical path selection screen which is an operation screen for selecting the clinical path 26 to be distributed among the extracted clinical path 26 to the terminal 16 of the user. If the user performs a selection operation to select the clinical path 26 through the clinical path selection screen, an operation signal corresponding to the selection operation is input from the terminal 16 of the user to the clinical path distribution unit 56. The clinical path distribution unit 56 distributes the clinical path 26 selected by the user to the terminal 16 of the user. The distributed clinical path 26 is displayed on the display of the terminal 16 of the user which is a distribution destination (see FIG. 3).

“Approval of Clinical Path”

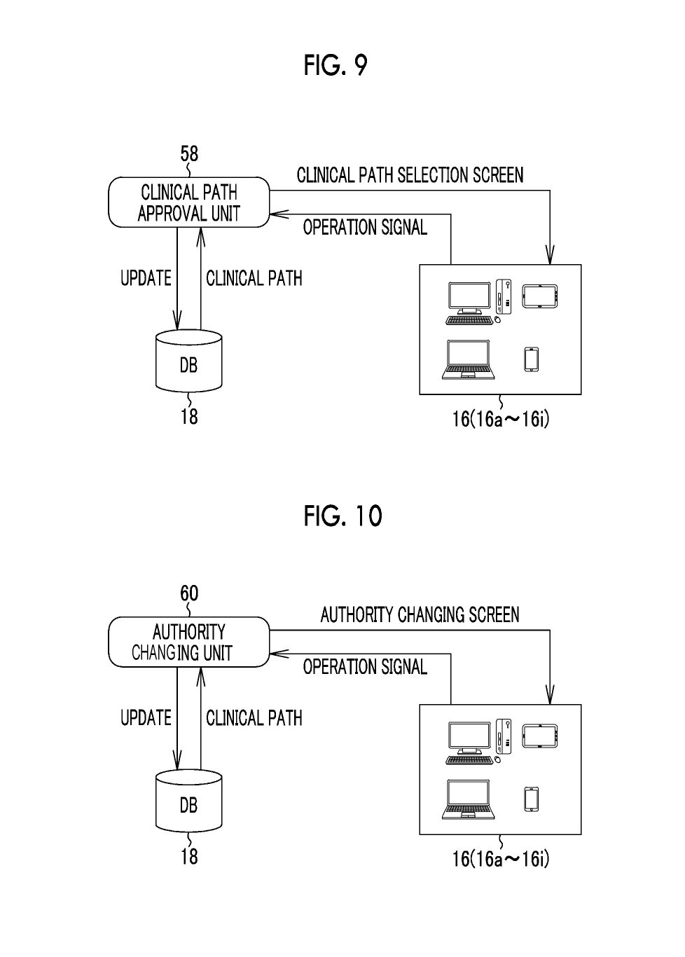

In FIG. 6, if “clinical path approval” is selected from among the four processes, the clinical path approval unit 58 is operated by the process selection unit 52. As illustrated in FIG. 9, the clinical path approval unit 58 extracts the clinical paths 26 for which the user has approval authority by referring to the authority information of the clinical path 26 stored in the clinical path DB 18 according to the operation, and distributes a clinical path selection screen which is an operation screen for selecting the clinical path 26 to be approved from among the extracted clinical paths 26, to the terminal 16 of the authenticated user. If the user performs a selection operation for selecting the clinical path 26 through the clinical path selection screen, an operation signal corresponding to the selection operation is input from the terminal 16 of the user to the clinical path approval unit 58.

If the clinical path 26 to be approved is selected, the clinical path approval unit 58 generates, for example, information (electronic signature) indicating that the clinical path is approved, and a certificate for certificating that this approval has been made from the terminal 16 of the user having approval authority through a scheme for performing electronic signature using a private key and a public key. The clinical path approval unit 58 stores the digital signature or the certificate in association with the approved clinical path 26 to update the clinical path DB 18.

Thus, the clinical path management device 12 stores the approval information indicating whether or not the clinical path 26 has been approved by the clinical path approval unit 58 in the clinical path DB 18 in association with the clinical path 26 (centralized management with the clinical path 26). Accordingly, the clinical path management device 12 can simultaneously confirm whether or not there is the approval associated with clinical path 26 when the clinical path 26 is viewed (see FIG. 3). Therefore, the treatment can smoothly start as compared with a case in which a written consent indicating whether or not there is the approval separately from the clinical path 26. Further, even when the user is at a place separated from a medical institution in which the treatment is performed, the user performs the approval over the network 14, and accordingly, time and effort for the patient to visit the medical institution in order to perform the approval can be omitted for convenience. Further, since the clinical path 26 and the approval information are centrally managed, it is possible to prevent human error, such as misunderstanding, as in a case in which the written consent is managed separately from the clinical path 26.

“Authority Change”

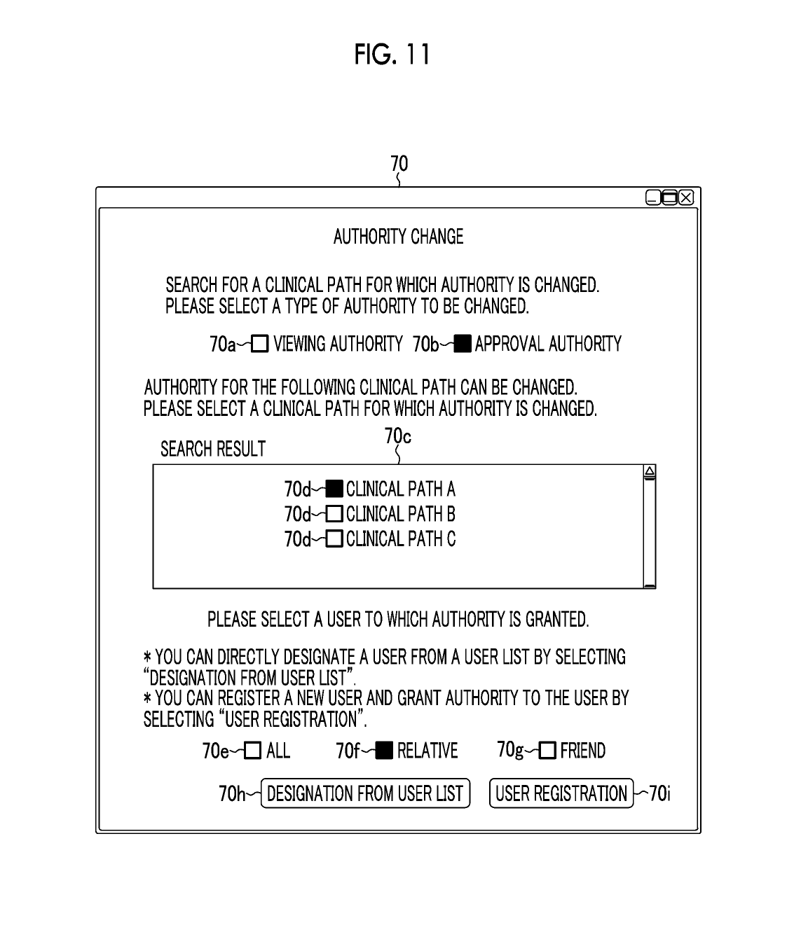

In FIG. 6, if “authority changing” is selected from among the four processes, the authority changing unit 60 is operated by the process selection unit 52. As illustrated in FIG. 10, the authority changing unit 60 distributes an authority changing screen 70 (see FIG. 11) which is an operation screen for addition or deletion of a user to which the viewing authority or the approval authority is granted according to the operation, to the terminal 16 of the user. If the user performs a change operation for changing the authority through the authority changing screen, an operation signal corresponding to the change operation is input from the terminal 16 of the user to the authority changing unit 60. The authority changing unit 60 rewrites the authority information of the clinical path 26 based on the input operation signal to update the clinical path DB 18.

As illustrated in FIG. 11, check boxes 70a and 70b are provided in an authority changing screen 70, and the user can select any one of the viewing authority and the approval authority to be changed by checking one of the check boxes 70a and 70b. If the check box 70a is checked, that is, if the viewing authority is selected as the authority to be changed, the authority changing unit 60 extracts the clinical path 26 for which the user has viewing authority changing authority (the clinical path 26 for which the viewing authority can be changed by the user) by referring to the clinical path DB 18, and displays the clinical path on a search result display portion 70c. If the check box 70b is checked, that is, if the approval authority is selected as the authority to be changed, the authority changing unit 60 extracts the clinical path 26 for which the user has approval authority changing authority (the clinical path 26 for which the approval authority can be changed by the user) by referring to the clinical path DB 18, and displays the clinical path on the search result display portion 70c.

In the search result display portion 70c, check boxes 70d are provided on the sides of the names of the respective displayed clinical paths, and the user can select the clinical path 26 for which the authority is changed, by checking any of the check boxes 70d.

If the clinical path 26 for which the authority is changed is selected, check boxes 70e to 70g, a user designation tag 70h, and a user registration tag 70i are displayed. The check boxes 70e to 70g are provided so that a user to which the authority is granted is selected from a preset group. The authority can be granted to all users registered in the user information DB 20 by checking the check box 70e, the authority can be granted to a user registered as a relative of the user in the user information DB 20 by checking the check box 70f, and the authority can be granted to a user registered as a friend of the user in the user information DB 20 by checking the check box 70g.

Normally, the viewing authority is granted to the friend but the approval authority is not granted to the friend. Accordingly, in a case in which the viewing authority is granted (when the check box 70a is checked), the check box 70g is displayed so that the check box 70g can be checked (the viewing authority can be granted to the friend), and in a case in which the approval authority is granted (when the check box 70b is checked), the check box 70g is not displayed so that the check box 70g cannot be checked (the approval authority cannot be granted to the friend), such that only the viewing authority can be granted to the friend (the approval authority cannot be granted).

The relative of the user is identified based on the user information 28 stored in the user information DB 20. For example, in FIG. 4, when a selection is performed to grant the approval authority (or viewing authority) of the clinical path of “Taro Fuji” to the relative (if the check box 70f is checked), the attribute of “Taro Fuji” of the user information 28 is referenced and “Daisuke Fuji” is identified to be the relative. The approval authority (or viewing authority) is granted to “Daisuke Fuji”. “Daisuke Fuji” to which the approval authority (or, viewing authority) has been granted can approve or view the clinical path of “Taro Fuji” through a procedure of the above-described “clinical path approval” (or “clinical path viewing”). Similarly, the friend of the user is identified based on the user information 28 stored in the user information DB 20, and the approval authority (or viewing authority) is granted.

Further, if the user designation tag 70h is operated, a user list of users registered in the user information DB 20 is displayed in a separate screen, and a user to which the authority is granted can be individually designated from the user list. Further, if the user registration tag 70i is operated, a user not registered in the user information DB 20 can be newly registered in the user information DB 20. The registered user is added to the user list displayed according to the operation of the user designation tag 70h, and the authority can be granted to the user by designating the user from the user list.

Thus, the clinical path management device 12 is convenient because addition or deletion of a user to which the viewing authority or the approval authority is granted can be performed. Further, in the clinical path management device 12, since the approval authority changing authority is granted to the patient and the attending doctor when the clinical path is newly created, the attending doctor can grant the approval authority to another user, such as the relative of the patient, and get the approval so that smooth treatment can start even in a case in which the patient cannot perform approval and, for example, the patient is unconscious or suffers from dementia.

In the present invention, since the approval information indicating whether or not the clinical path has been approved may be associated with the clinical path, a detailed configuration is not limited to the above embodiment and may be appropriately changed. For example, while the example in which the authority information is directly attached to the clinical path has been described in the above embodiment, the authority information may be attached to the user information. In this case, since a correspondence relationship between the clinical path and the user information is recorded, the authority information is indirectly associated through the user information.

While the example in which the clinical path management device is installed in the management company that manages the medical support system has been described in the above embodiment, an installation place of the clinical path management device can be freely set and accordingly, for example, the clinical path management device may be installed in a medical institution (such as a hospital).

Further, while the example in which the user manually inputs the user information has been described in the above embodiment, for example, user information used in a system (hereinafter, another system) separate from the medical support system, such as a resident registry network or a gross national uniform number system, may be transmitted from the other system to the clinical path management system in an on-line manner, and the manual input of the user information may be omitted. In this case, for example, the identification information of the user may be input to the clinical path management device so as to instruct to transmit a distribution request for user information from another system. It is considered that, based on this instruction, the clinical path management device accesses another system, acquires user information (for example, name, age, address, family relationship, or occupation) other than the identification information in an on-line manner, and automatically registers the user information.

Further, the clinical path management device may transmit a distribution request for necessary information at a necessary timing and acquire the information, instead of acquiring all information of users in another system at once. For example, in a case in which the approval authority is granted to a user as a relative of the patient and it becomes necessary to identify whether the user is the relative of the patient, information indicating a family relationship such as whether the user is the relative, among the user information, is acquired each time through access the other system. The clinical path management device identifies whether the user is the relative of the patient based on the acquired information, and grant the approval authority in a case in which the user is identified as the relative.

A scheme of identifying the relative of the user is not limited to, for example, a method of registering the name of relative as the attribute of the user, and a terminal ID of the relative may be registered and the relative may be identified based on the terminal ID. Further, body information (for example, fingerprint, voiceprint, iris, or facial image) of the relative may be registered and the relative of the user may be identified based on fingerprint authentication, voiceprint authentication, pupil authentication, or face recognition. It is understood that the information for identifying the relative of the user is not limited to storage of the information in the user information DB as the user information, and the information may be stored in the terminal 16 of the user or stored in a contract company with which the terminal 16 of the user has contracted (for example, a communication company in a case in which the terminal 16 of the user is a phone (a smart phone)) and referred to through access to the contract company so that the information may be used to identify the relative of the user. Further, the registration (storage) of information for identifying the relative of the user can be performed at any timing.

Further, while the example in which the user having the viewing authority can view all information on the clinical path for which the user has the viewing authority has been described in the above embodiment, restricted viewing authority with which only some pre-designated information among the information included in the clinical path can be viewed may be provided, and a type of information that can be viewed by a user may be adjusted according to users. Thus, for example, the relative can be caused to view all the information and the friend can be caused to view only a portion of the information, or the user on the medical institution side can be caused to view all the information and the user on the patient side can be caused to view only single information. Thus, in a case in which information that can be viewed is restricted, it is preferable that the user having the viewing authority changing authority cannot grant the viewing authority to other users for information of which viewing by the user is restricted.

Further, while the example in which the user having the approval authority changing authority can grant the approval authority to any user has been described in the above embodiment, restricted approval authority changing authority with which the approval authority can be granted to only some previously designated users may be provided, and the users to which the approval authority can be granted may be different according to users. By doing so, for example, the patient can grant the approval authority to any user, and the attending doctor can grant the approval authority to only relatives of the patient.

Further, while the example in which the authority granted in the initial state are different between the doctor and other medical staffs in a case in which the user is in a standpoint of the medical institution in the above embodiment has been described, different authority may be granted to doctors according to job titles or departments. Further, different authority may be similarly granted to medical staffs other than doctors according to job titles or departments.

Further, while the example in which the user to which the authority has been granted can exercise the authority at any place regardless of the position of the user has been described in the above embodiment, the authority to be granted to the user may be restricted based on a current position of the user. In this case, for example, it is considered that a current location of the terminal 16 of the user is detected using a GPS system or like, the viewing authority cannot be exercised (a user having viewing authority cannot view the clinical path) in a case in which the current location is separated by a predetermined distance or more from the medical institution, or the approval authority or the approval authority changing authority cannot be exercised in a case in which the current location is separated by a predetermined distance or more from the patient. It is understood that the authority to be granted to the user may be restricted according to whether authentication code is correctly input, as well as the location information.

Further, when the clinical path is viewed, a viewing history such as when the clinical path is viewed or which of users views the clinical path may be recorded. Further, there may be provided a function of notifying of a timing of the event set in the clinical path. In this case, it is preferable to notify the user, the patient, his or her relative, the attending doctor, or the like having the viewing function of the timing of the event. It is understood that the user notified of the event can be set by the user. Further, if the event starts, the terminals 16 of the users may be connected to each other by a voice or video telephone system, and a state of the event may be relayed to the user separated from a place of the event. In a case in which the event is relayed, there is a problem in that the user on the patient side does not know meanings of terminology or the like used by the user on the medical institution side. Accordingly, it is preferable that the terminology is detected through voice recognition, and a commentary is displayed on the screen or the commentary is provided through voice guidance. It is understood that sound or image data obtained by the relaying may be recorded in association with the clinical path.

Although the present invention has been fully described by the way of the preferred embodiment thereof with reference to the accompanying drawings, various changes and modifications will be apparent to those having skill in this field. Therefore, unless otherwise these changes and modifications depart from the scope of the present invention, they should be construed as included therein.

What is claimed is:

1. A clinical path management device comprising:
a clinical path database in which a clinical path showing a treatment plan of a patient is stored;
a user information database in which user information of a user is stored;
a user authentication unit that authenticates the user based on the user information; and
a clinical path approval unit that associates information indicating that the treatment plan has been approved with the clinical path upon an input of an instruction to approve the treatment plan from a user having approval authority for approving the treatment plan.

2. The clinical path management device according to claim 1, further comprising an approval authority changing unit that receives an instruction to grant or delete the approval authority from a user having approval authority changing authority for granting or deleting the approval authority, and grants or deletes the approval authority upon an input of the instruction.

3. The clinical path management device according to claim 2, further comprising a clinical path distribution unit that receives an instruction to view the clinical path from a user having viewing authority for viewing the clinical path, and distributes the clinical path upon an input of the instruction.

4. The clinical path management device according to claim 3, further comprising a clinical path creation unit that receives an instruction to create the clinical path from a user having creation authority for creating the clinical path, and creates the clinical path upon an input of the instruction.

5. The clinical path management device according to claim 4,
wherein authority owned by the user is stored in association with the clinical path.

6. The clinical path management device according to claim 4,
wherein preset authority is granted to a pre-set user at the time of creation of the clinical path.

7. The clinical path management device according to claim 6,
wherein the approval authority is granted to the patient who is a treatment target in the clinical path at the time of creation of the clinical path, and
the approval authority changing authority is granted to the patient and an attending doctor of the patient.

8. The clinical path management device according to claim 7,
wherein the approval authority changing authority granted to the attending doctor is authority for granting the approval authority to only a relative of the patient.

9. The clinical path management device according to claim 6,
wherein the viewing authority is granted to the patient who is a treatment target in the clinical path, and the attending doctor of the patient, at the time of creation of the clinical path.

10. The clinical path management device according to claim 9,
wherein the viewing authority granted to the attending doctor is authority for viewing all information constituting the clinical path, and
the viewing authority granted to the patient is authority for viewing only a part of the information constituting the clinical path.
